(19) United States
(12) Patent Application Publication
(10) Pub. No.: US 2006/0236278 A1
(43) Pub. Date: Oct. 19, 2006

(54) METHOD OF AUTOMATIC GENERATION OF MICRO CLOCK GATING FOR REDUCING POWER CONSUMPTION

(75) Inventor: Ilan Shimony, Haifa (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/907,869

(22) Filed: Apr. 19, 2005

(51) Int. Cl. G06F 17/50; G06F 1/00; G06F 9/45

(52) U.S. Cl. 716/6; 716/18; 713/300; 713/500

(57) ABSTRACT

A method and apparatus for reducing transitions thereby reducing power consumption for a clocked output state-holding element having inputs that are respective logic functions of one or more clocked input state-holding elements. A respective valid line is associated with each of the clocked input state-holding elements whose value indicates whether a respective input of the clocked input state-holding element is valid. The clocked output state-holding element is clock gated only if the respective inputs of all of the clocked input state-holding elements coupled to the clocked output state-holding element are indicated as being valid.

### FIELD OF THE INVENTION

This invention relates to VLSI design and synthesis.

### BACKGROUND OF THE INVENTION

The entire contents of the references discussed in this section below are incorporated herein by reference.

Power consumption of integrated circuits is becoming more and more a critical problem because of the profusion of mobile battery powered devices, and the increased usage of dense racks in computing, storage, and networking devices. On the other hand the increased complexity and quantity of active logic circuitry on a chip leaves the chip designer less and less time to tune the power consumption of each and every module or sub-module in his design. The ensuing increased usage of CAD tools further distances the designer from the actual gates used for the implementation, thus making it more difficult for the designer to achieve the design's power consumption goal.

Two of the current solutions for power consumption reduction are the use of asynchronous logic (Andrew Lines, “Asynchronous circuits: better power by design”, EDN, May 1, 2003, p. 79-82; Max Baron, “Technology 2001: On A Clear Day You Can See Forever”, Microprocessor Report, Feb. 25, 2002) and clock gating (Benini and De Micheli, “Automatic synthesis of low-power gated-clock finite-state machines”, IEEE Transactions on Computer-Aided Design of Integrated Circuits and Systems, Volume 15, Issue: 6, Jun. 1996, p. 630-643; Benini, Siegel, and De Micheli, “Saving power by synthesizing gated clocks for sequential circuits”, IEEE Design & Test of Computers, Volume 11, Issue 4, Winter 1994, p. 32-41). Clock gating reduces power by shutting off complete modules in the design when they are not performing a useful function, but it has the disadvantage of requiring additional design effort to control when and where the clock is gated. Because of that effort in general clock gating is used in a very coarse grained way, or on specific modules (for example Finite State Machines used to construct a sequencer with logic gates and flip-flops, special multiplier hardware, etc.). Asynchronous design is not inherently more power efficient, but since there is no clock, the logic does not toggle when not needed, thus saving power under most operating conditions, except for peak activity times. The power required to toggle the clock is proportional to 0.5-C-V2-f, where:

C=capacitance;

V=voltage; and

f=frequency.

The clock line is usually highly loaded with high capacitance, and so toggling it requires significant power.

The main disadvantage of asynchronous design is the difficulty of design, verification, and testing of such devices. These difficulties are further exacerbated by the lack of tools and methodologies for asynchronous design.

U.S. Pat. No. 6,832,363 to Sharp Kabushiki Kaisha of Japan, published Dec. 14, 2004 and entitled “High-level synthesis apparatus, high-level synthesis method, method for producing logic circuit using the high-level synthesis method, and recording medium” discloses a high-level synthesis apparatus for synthesizing a register transfer level logic circuit from a behavioral description describing a processing operation of the circuit. The apparatus comprises a low power consumption circuit generation section for generating a low power consumption circuit which stops or inhibits circuit operations of partial circuits constituting the logic circuit only when the partial circuits are in a wait state, so as to achieve low power consumption. The low power consumption circuit generation section is synthesized along with the logic circuit.

US2004/0153981A1 (Wilcox et al.) published Aug. 5, 2004 and entitled “Generation of clock gating function for synchronous circuit” discloses a method and apparatus for determining a clock gating function for a set of clocked state-holding elements. For each element, the conditions are determined under which the element will hold its current value based only on those inputs which are common to all elements; and the conditions are combined to form a gating function. The background of this reference provides a good explanation for the high power consumption associated with clocking synchronous circuits and of the desirability of avoiding this where possible. This reference deals with reduction of power consumption by optimizing the clock gating based on the input cone of each state element, and trying to find when the state remains the same in order to gate the clock.

Practically all logic synthesis tools break an RTL (Register Transfer Language) coded design into stages such as depicted in FIG. 1. RTL is a subset of HDL (Hardware Design Language) and usually employs a lower level of code description, where each register in the design is listed. HDL may contain high level objects which might even not be implementable in logic. In the present description, these acronyms are used interchangeably. The design is split into ‘islands’ of combinatorial logic, enclosed by input register and output registers. Thus, FIG. 1 shows schematically a synchronous logic circuit 10 having two gated input registers 11 and 12 and a gated output register 13 synthesized directly according to known methods and interconnected by a combinatorial island 14. Once the combinatorial island 14 is identified, random logic optimization is carried out on it. This allows a straightforward implementation of the “micro clock gating” scheme by an automatic tool, thus greatly assisting the designer in achieving a low power design.

The circuit 10 depicts a typical logic stage, with two registered logic inputs (A_{d}, B_{d}), clock (clk), and registered output C_{d}. The combinatorial logic island is a simple “XOR” gate. In a first stage of the synthesis, the logic circuit is defined using a Hardware Definition Language (HDL), such as the following VHDL of Verilog that may be used to synthesize the logic circuit 10.

```
    -- Naming convention:
-- d suffix : register input
-- q suffix : register output
    library ieee;
use ieee.std_logic_1164.all;
    entity mcg_fig1 is
port(
clk : in std_logic; -- clock input
Ad : in std_logic; -- input a
Bd : in std_logic; -- input b
Cq : out std_logic -- output c
);
end entity mcg_fig1;
    architecture arc of mcg_fig1 is
signal Aq : std_logic;
signal Bq : std_logic;
signal Cd : std_logic;
begin
    -- input register A
A_reg: process (clk)
begin
if clk'event and clk = ‘1’ then
Aq <= Ad;
end if;
end process A_reg;
    -- input register B
B_reg: process (clk)
begin
if clk'event and clk = ‘1’ then
Bq <= Bd;
end if;
end process B_reg;
    -- example of combinatorial logic island
Cd <= Aq xor Bq;
    -- output register C
C_reg: process (clk)
begin
if clk'event and clk = ‘1’ then
Cq <= Cd;
end if;
end process C_reg;
end arc;
```

FIG. 1 depicts the direct implementation, as might be generated by current synthesis tools, of the above code showing a simple 2-input, 1-output stage, where all inputs and outputs are registered. The requirement to register all inputs and outputs imposes an overhead on the power consumption and this overhead is, of course, greatly increased as more registers are included in the circuit.

### SUMMARY OF THE INVENTION

It is therefore an object of the invention to reduce power consumption in digital circuits containing clocked registers.

It is a particular objective to approach the low power consumption typically associated with asynchronous circuits also in a synchronous combinatorial logic circuit, while utilizing the old and proven synchronous logic methodologies and tools.

According to a first aspect of the invention there is provided a method of reducing transitions thereby reducing power consumption for a clocked output state-holding element having inputs that are respective logic functions of one or more clocked input state-holding elements, the method comprising:

associating with each of said clocked input state-holding elements a respective valid line whose value indicates whether a respective input of the clocked input state-holding element is valid; and

clock gating the clocked output state-holding element only if the respective inputs of all of the clocked input state-holding elements coupled to the clocked output state-holding element are indicated as being valid.

According to a second aspect of the invention there is provided a high-level synthesis method for synthesizing a register transfer level logic circuit comprising a clocked output state-holding element having inputs that are respective logic functions of one or more clocked input state-holding elements, the method comprising:

synthesizing for each of said clocked input state-holding elements a respective synthesized clocked input state-holding element;

synthesizing for each of said clocked input state-holding elements a respective valid line whose value indicates whether a respective input of the clocked input state-holding element is valid;

synthesizing a synthesized clocked output state-holding element; and

synthesizing logic coupled to each of said synthesized clocked input state-holding elements and to said synthesized clocked output state-holding element for conveying a clock gating signal to the synthesized clocked output state-holding element only if the respective inputs of all of the synthesized clocked input state-holding elements coupled to the synthesized clocked output state-holding element are indicated as being valid.

The invention utilizes one of the common asynchronous design methodologies whereby a forward valid line is used in each stage of the design, which signals the next stage the validity of new data. In a similar way, the invention provides a valid line in a synchronous design which is used to gate the clock to the relevant register. If the valid line indicates that one or more inputs to the register are not valid, then logic circuitry prevents the register from being clocked, thereby saving energy and reducing power consumption.

### BRIEF DESCRIPTION OF THE DRAWINGS

FIG. 1 is schematic representation of a synchronous logic circuit having gated registers as synthesized according to known prior art methods.

FIG. 2 is schematic representation of the synchronous logic circuit shown in FIG. 1 as synthesized according to a first exemplary embodiment of the invention.

FIG. 3 is schematic representation of a synchronous logic circuit having a feedback loop as synthesized according to a second exemplary embodiment of the invention.

FIG. 4 is a partial flow diagram summarizing the principal actions carried out by a method according to an exemplary embodiment of the invention for optimizing synchronous logic circuits.

FIGS. 5 and 6 are block diagrams showing functionalities of high-level synthesis apparatuses according to exemplary embodiments of the invention.

### DETAILED DESCRIPTION OF THE INVENTION

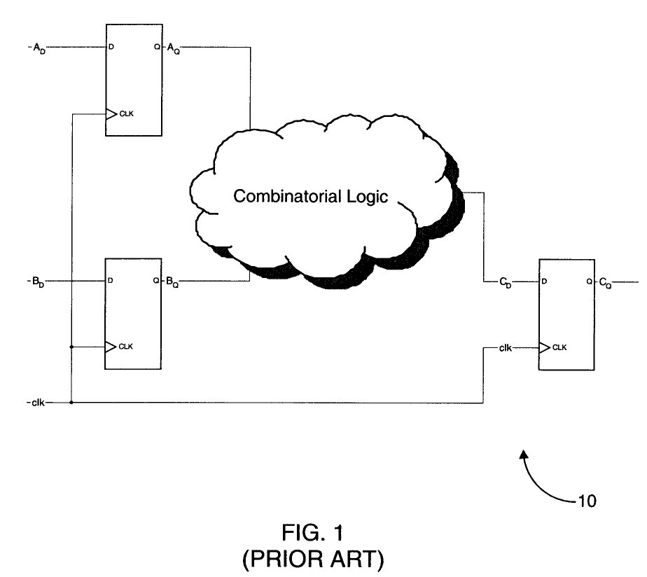

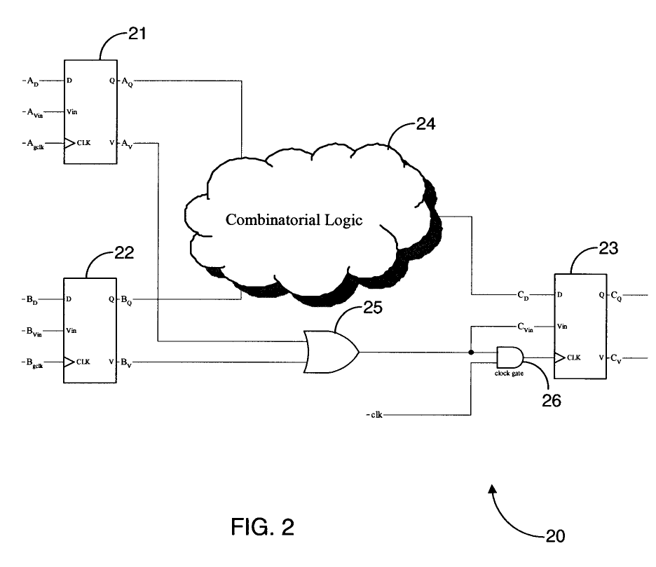

FIG. 2 is schematic representation of a synchronous logic circuit 20 having two gated input registers 21, 22 (constituting clocked input state-holding elements) and a gated output register 23 (constituting a clocked output state-holding element) interconnected by a combinatorial logic island 24. The synchronous logic circuit 20 is functionally identical to the synchronous logic circuit 10 shown in FIG. 1 but the registers 21, 22 and 23 are synthesized using valid signals propagation as is now explained. To this end, there are added to each of the registers valid input and output lines suffixed Vᵢₙ and V respectively. Within the context of the present invention and appended claims a ‘valid’ line indicates that a transition occurred on that line, and so the output might change, thus it needs latching. Once any value has changed, either A or B, it is thus necessary to ensure that the (potentially) new output value is captured. To this end, the respective valid output lines A_{Vout} and B_{Vout} of the two input registers 21 and 22 are fed to a 2-input OR-gate 25 whose output is fed to one input of a 2-input AND-gate 26 and constitutes the valid input signal, C_{Vin}, of the output register 23. The other input of the AND-gate 26 is connected to the CLK signal and the output of the AND-gate 26 is connected to the clock input of the output register 23. Input A_{Vin} validates signal A_{D}, while B_{Vin} and C_{Vin} validate signals B_{D} and C_{D} respectively. The valid input signal, C_{Vin,} for the output register 23 is created as a function of the valid output signals, A_{V} and B_{V}. Only if A_{V} and B_{V} indicate that A_{D} and B_{D} are valid will the output register 23 be clocked, thus saving power compared with the common synchronous designs, where the output register is clocked every cycle. The logic circuit 20 may be synthesized using following VHDL code.

```
    -- Naming convention:
-- gclk suffix : gated clock
-- d suffix : register input
-- q suffix : register output
-- v suffix : valid signal
-- vin suffix : valid in
    library ieee;
use ieee.std_logic_1164.all;
    entity mcg_fig2 is
port(
clk : in std_logic; -- clock input
Ad : in std_logic; -- input a
Avin : in std_logic;
Agclk : in std_logic;
Bd : in std_logic; -- input b
Bvin : in std_logic;
Bgclk : in std_logic;
Cq : out std_logic; -- output c
Cv : out std_logic
);
end entity mcg_fig2;
    architecture arc of mcg_fig2 is
signal Aq : std_logic;
signal Av : std_logic;
signal Bq : std_logic;
signal Bv : std_logic;
signal Cd : std_logic;
signal Cvin : std_logic;
signal clk_g : std_logic; -- gated clock
    begin
    -- input register A
A_reg: process (Agclk)
begin
if Agclk'event and Agclk = ‘1’ then
Aq <= Ad;
Av <= Avin;
end if;
end process A_reg;
    -- input register B
B_reg: process (Bgclk)
begin
if Bgclk'event and Bgclk = ‘1’ then
Bq <= Bd;
Bv <= Bvin;
end if;
end process B_reg;
    -- gated clock logic
Cvin <= Av or Bv;
clk_g <= clk and Cvin;
    -- example of combinatorial logic island
Cd <= Aq xor Bq after 1 ns;
    -- output register C
C_reg: process (clk_g)
begin
if clk_g'event and clk_g = ‘1’ then
Cq <= Cd;
end if;
end process C_reg;
    -- Cv logic
Cv_reg: process (clk)
begin
if clk'event and clk = ‘1’ then
Cv <= Cvin;
end if;
end process Cv_reg;
end arc;
```

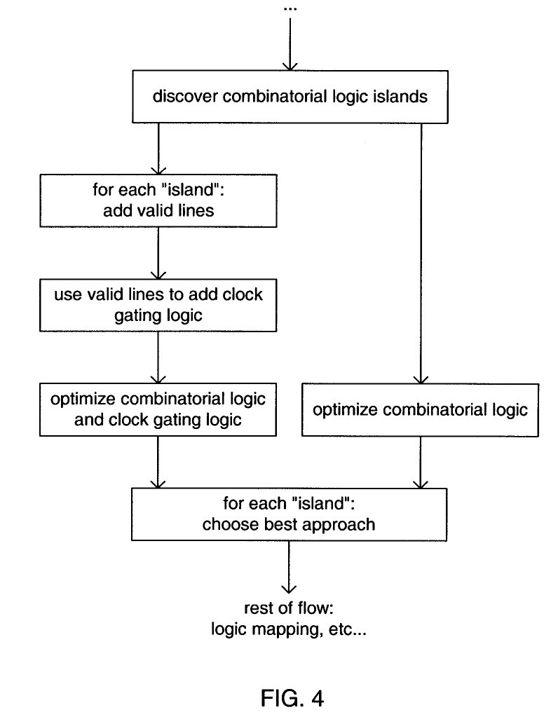

Implementing the above code causes the logic circuit 20 in FIG. 2 to be synthesized with exactly the same functionality as the logic circuit 10 shown in FIG. 1. On the other hand, clock gating to the output register 23 can occur only if the respective inputs AD and BD of the input registers 21 and 23 to which the output register 23 is coupled are indicated as being valid. Therefore, the logic circuit 20 consumes less power than the synchronous logic circuit 10, where the output register is clocked every cycle. Although the logic consumes less power, additional power is required in the added logic, thus giving rise to a trade off described below with reference to FIG. 4. The designer has to state the boundary valid conditions explicitly, while the synthesis tool will automatically propagate the valid signals throughout the design.

Current timing tools need no modification, as long as they can recognize and handle clock gating. During synthesis, a race condition should be avoided by making sure the valid signal path is shorter than all logic paths crossing the combinatorial logic island. For simulation, where the timing model is artificial (RTL simulation usually uses ‘delta delay’ where each function has a delay which is smaller than the simulation's delay granularity), delay is specifically added in order to ensure that the valid signal path is shorter than all logic paths crossing the combinatorial logic island. This is shown by the addition of a 1 ns delay in the code defining the combinatorial logic island. During the physical design stages analysis is done using timing tools, and in case of problem timing is fixed by choosing one of several options (such as changing the drive strength of the logic gates, or adding delay logic).

Verification and post-silicon tests are no different then a fully synchronous design since everything still behaves in a synchronous way, although all clocks are asynchronous by the common definition of synchronous design. An added benefit which occurs is clock dithering, i.e. not all latches gate at the same time. By averaging peak clock current consumption, electromigration and power drop problem are mitigated.

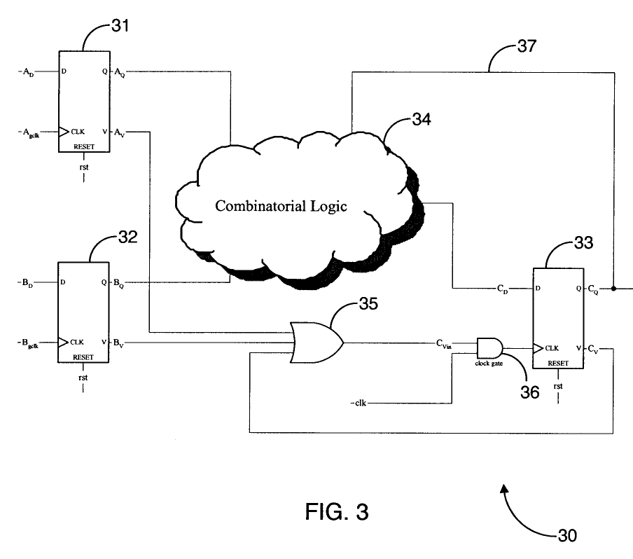

FIG. 3 is schematic representation of a synchronous logic circuit 30 having two gated input registers 31, 32 (constituting clocked input state-holding elements) and a gated output register 33 (constituting a clocked output state-holding element) interconnected by a combinatorial logic island 34. In the synchronous logic circuit 30 the registers 31, 32 and 33 are synthesized using valid signals as explained above with reference to FIG. 2. Thus, the respective valid output lines A_{V} and B_{V} of the two input registers 31 and 32 are fed to respective inputs of an OR-gate 35 whose output is fed to one input of a 2-input AND-gate 36 whose other input is connected to the CLK signal and whose output is connected to the CLK input of the output register 33. The OR-gate 35 has a third input that is coupled to the valid output, C_{V} of the output register 33. Moreover, a feedback path 37 connects the C_{Q} output of the output register 37 to the combinatorial logic island 34.

In this arrangement, valid signals are not propagated and there is therefore no need for valid input signals in the input registers 31 and 32 or in the output register 33, although all three registers still have respective valid output lines designated A_{V}, B_{V}, and C_{V}, respectively. Instead of propagating the valid signals, each register detects a changed state and indicates that condition on the valid output line so that the valid output lines A_{V}, B_{V}, and C_{V} indicate a transition on lines A_{Q}, B_{Q}, or C_{Q} respectively. Any change in one of the inputs of the combinatorial logic island 34 causes the output register 33 to latch by gating its clock. This scheme is particularly suitable whenever a feedback path exists, for example in a state machine implementation. Indeed, this is how the Finite State Machines mentioned above are implemented, by using outputs of the latches as inputs to the logic.

The logic circuit 30 may be synthesized using following VHDL code.

```
    -- Naming convention:
-- gclk suffix : gated clock
-- d suffix : register input
-- q suffix : register output
-- v suffix : valid signal
-- vin suffix : valid in
    library ieee;
use ieee.std_logic_1164.all;
    entity mcg_fig3 is
port(
rst : in std_logic; -- reset input
clk : in std_logic; -- clock input
Ad : in std_logic; -- input a
Agclk : in std_logic;
Bd : in std_logic; -- input b
Bgclk : in std_logic;
Cq : out std_logic -- output c
);
end entity mcg_fig3;
    architecture arc of mcg_fig3 is
    component df_tr
port (
rst : in std_logic;
clk : in std_logic;
D : in std_logic;
Q : out std_logic;
V : out std_logic);
end component;
    signal Aq  : std_logic;
signal Av  : std_logic;
signal Bq  : std_logic;
signal Bv  : std_logic;
signal Cd  : std_logic;
signal Cq_local : std_logic;
signal Cv  : std_logic;
signal Cvin  : std_logic;
signal clK_g  : std_logic;  -- gated clock
    begin
    -- input register A
A_reg: df_tr port map (
rst => rst,
clk => Agclk,
D => Ad,
Q => Aq,
V => Av);
    -- input register B
B_reg: df_tr port map (
rst => rst,
clk => Bgclk,
D => Bd,
Q => Bq,
V => Bv);
    -- gated clock logic
Cvin <= Av or Bv or Cv;
clK_g <= clk and Cvin;
    -- example of combinatorial logic island with feedback
Cd <= Aq xor Bq xor Cq_local after 1 ns;
    -- output register C
C_reg: df_tr port map (
rst => rst,
clk => clk_g,
D => Cd,
Q => Cq_local,
V => Cv);
    Cq <= Cq_local;
    end arc;
    -- example of d-flip-flop with transition detection
    library ieee;
use ieee.std_logic_1164.all;
    entity df_tr is
    port (
rst : in std_logic; -- reset input
clk : in std_logic; -- clock input
D : in std_logic; -- input
Q : out std_logic; -- output
V : out std_logic); -- output valid
    end df_tr;
    architecture arc of df_tr is
      signal Ddelayed : std_logic;
    begin
    Ddelayed_reg: process (clk)
begin
if rst = ‘1’ then
Ddelayed <= ‘0’;
elsif clk'event and clk = ‘1’ then
Ddelayed <= D;
end if;
end process Ddelayed_reg;
    Q_reg: process (clk)
begin
if rst = ‘1’ then
Q <= ‘0’;
elsif clk'event and clk = ‘1’ then
Q <= D;
end if;
end process Q_reg;
    V_reg: process (clk)
begin
if rst = ‘1’ then
V <= ‘0’;
elsif clk'event and clk = ‘1’ then
V <= Ddelayed xor D;
end if;
end process V_reg;
    end arc;
```

FIG. 4 is a partial flow diagram summarizing the principal actions carried out by a method according to the invention for optimizing power consumption in a logic circuit that is reducible to input registers coupled to output registers via one or more combinatorial logic islands. Thus, the circuit is analyzed to determined combinatorial logic islands. A simple exemplary discovery process for doing this uses a graph traversal algorithm (over the netlist). This is a basic algorithm that is common knowledge to synthesis writers. The combinatorial logic islands are then individually optimized both according to known methods as described, for example, in U.S. Pat. No. 6,832,363 and in accordance with the invention. Thus according to the invention, valid lines are used to add clock gating logic and the combined combinatorial logic island and clock gating logic are optimized as described above with reference to FIGS. 2 and 3 of the drawings. For each combinatorial logic island there exist two optimizations: one according to known approaches that do not require the additional valid lines and associated logic associated with the invention; and the other requiring the additional valid lines and associated logic associated with the invention. For each combinatorial logic island, the best approach is selected for actual logic circuit synthesis by evaluating the power saving achieved for the respective combinatorial logic island and determining if it is worth the added logic. This is done automatically, by estimating the power consumption of each branch, and choosing the lower consumption one using any of the many algorithms for power estimation that are known in the art.

If the power saved is offset by the power used by the added logic then the respective combinatorial logic island is used “as is”, and the output's valid lines (which are needed for the next logic stage) are generated using auxiliary logic, such as described above with reference to FIG. 3 and included in the VHDL code thereof under the caption “entity ‘df_tr’: d-flip-flop with transition detection”.

In the method according to the invention, the RTL code does not need any changes, since the synthesis tool takes care of adding the necessary logic. Moreover, there is no need to change the synchronous-clock design methodologies and tools for design, verification, and testing of the design, which is one of the main problems in asynchronous logic design i.e. same timing tools, test generation tools are used.

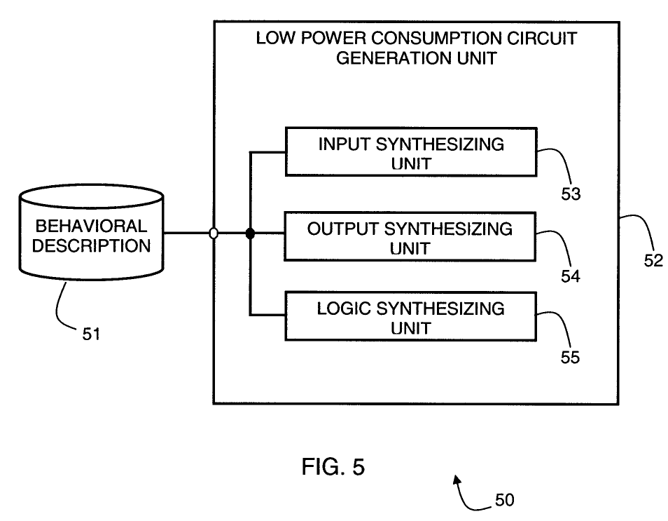

FIG. 5 is a block diagram showing the functionality of a high-level synthesis apparatus 50 according to an exemplary embodiment of the invention for synthesizing a register transfer level logic circuit comprising at least one clocked output state-holding element responsively coupled to at least one clocked input state-holding element from a behavioral description 51 describing a processing operation of the logic circuit. The high-level synthesis apparatus 50 comprises a low power consumption circuit generation unit 52 for generating a low power consumption circuit which stops or inhibits circuit operations of the clocked output state-holding elements unless a respective input to any one of the clocked input state-holding elements is valid. It does this as described in detail above with reference to FIGS. 2 to 4, by stopping or reducing clock supply to the clocked output state-holding elements, so to achieve low power consumption.

The low power consumption circuit generation unit 52 includes an input synthesizing unit 53 responsive to the behavioral description 51 for synthesizing for each of the clocked input state-holding elements a respective synthesized clocked input state-holding element and a respective valid line whose value indicates whether a respective input of the clocked input state-holding element is valid. The low power consumption circuit generation unit 52 further includes an output synthesizing unit 54 responsive to the behavioral description 51 for synthesizing a synthesized clocked output state-holding element. A logic synthesizing unit 55 within the low power consumption circuit generation unit 52 is responsive to the behavioral description 51 for synthesizing logic coupled to each of the synthesized clocked input state-holding elements and to the synthesized clocked output state-holding element for conveying a clock gating signal to the synthesized clocked output state-holding element only if the respective inputs of all of the synthesized clocked input state-holding elements coupled to the synthesized clocked output state-holding element are indicated as being valid.

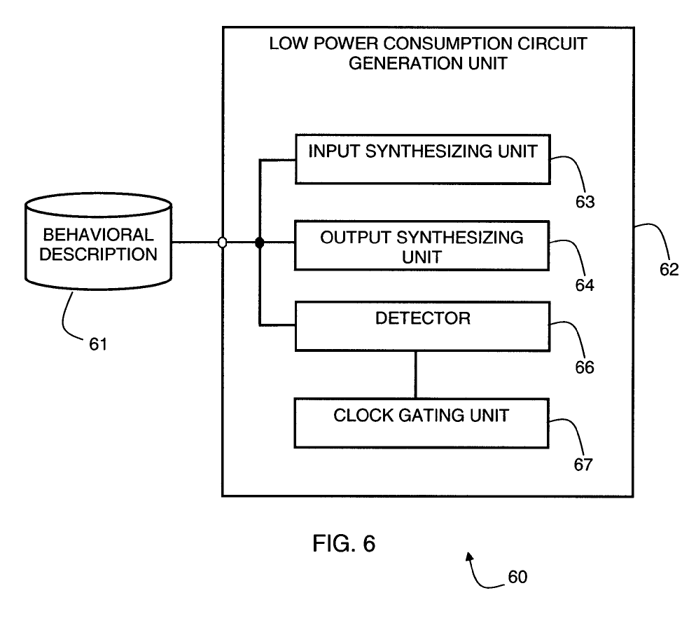

FIG. 6 is a block diagram showing the functionality of a high-level synthesis apparatus 60 according to another exemplary embodiment of the invention, having a low power consumption circuit generation unit 62 that includes an input synthesizing unit responsive 63 to a behavioral description 61 for synthesizing for each of the clocked input state-holding elements a respective synthesized clocked input state-holding element and a respective valid line whose value indicates whether a respective input of the clocked input state-holding element is valid. An output synthesizing unit 64 is responsive to the behavioral description 61 for synthesizing a synthesized clocked output state-holding element, and a detector 66 detects a changed state for each of the synthesized clocked input state-holding elements coupled to the synthesized clocked output state-holding element and indicating a changed state on the valid line of the respective synthesized clocked input state-holding element. A clock gating unit 67 is responsively coupled to the detector 66 for gating the clock of the synthesized clocked output state-holding element so as to latch the synthesized clocked output state-holding element whenever a changed state is detected in one or more of the synthesized clocked input state-holding elements coupled to the synthesized clocked output state-holding element.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

What is claimed is:

1. A method of reducing transitions thereby reducing power consumption for a clocked output state-holding element having inputs that are respective logic functions of one or more clocked input state-holding elements, the method comprising:
associating with each of said clocked input state-holding elements a respective valid line whose value indicates whether a respective input of the clocked input state-holding element is valid; and
clock gating the clocked output state-holding element only if the respective inputs of all of the clocked input state-holding elements coupled to the clocked output state-holding element are indicated as being valid.

2. The method according to claim 1, further including:
associating with said clocked output state-holding element a valid line that indicates whether the input of the clocked output state-holding element is valid and whose value is a function of the respective valid lines of the clocked input state-holding elements coupled to the clocked output state-holding element; and
propagating the respective values of the valid lines of said clocked input state-holding elements to the valid line of the clocked output state-holding element.

3. The method according to claim 1, further including:
detecting a changed state for each of the clocked input state-holding elements coupled to the clocked output state-holding element and indicating a changed state on the valid line of the respective clocked input state-holding element; and
the clock of the clocked output state-holding element so as to latch the clocked output state-holding element whenever a changed state is detected in one or more of the clocked input state-holding elements coupled to the clocked output state-holding element.

4. A high-level synthesis method for synthesizing a register transfer level logic circuit comprising a clocked output state-holding element having inputs that are respective logic functions of one or more clocked input state-holding elements, the method comprising:
synthesizing for each of said clocked input state-holding elements a respective synthesized clocked input state-holding element;
synthesizing for each of said clocked input state-holding elements a respective valid line whose value indicates whether a respective input of the clocked input state-holding element is valid;
synthesizing a synthesized clocked output state-holding element; and
synthesizing logic coupled to each of said synthesized clocked input state-holding elements and to said synthesized clocked output state-holding element for conveying a clock gating signal to the synthesized clocked output state-holding element only if the respective inputs of any of the synthesized clocked input state-holding elements coupled to the synthesized clocked output state-holding element are indicated as being valid.

5. The high-level synthesis method according to claim 4, further including:
synthesizing for said clocked output state-holding element a valid line whose value indicates whether an input of the clocked output state-holding element is valid and whose value is a function of the respective valid lines of the clocked input state-holding elements coupled to the clocked output state-holding element; and
propagating the respective values of the valid lines of said synthesized clocked input state-holding elements to the valid line of the synthesized clocked output state-holding element.

6. The method according to claim 4, further including:
detecting a changed state for each of the synthesized clocked input state-holding elements coupled to the synthesized clocked output state-holding element and indicating a changed state on the valid line of the respective synthesized clocked input state-holding element; and
gating the clock of the synthesized clocked output state-holding element so as to latch the clocked output state-holding element whenever a changed state is detected in one or more of the synthesized clocked input state-holding elements coupled to the synthesized clocked output state-holding element.

7. A method for producing a logic circuit, wherein a high-level synthesis method according to claim 4 is used to design the logic circuit.

8. A computer readable recording medium comprising a control program for executing the high-level synthesis method according to claim 4.

9. A high-level synthesis apparatus for synthesizing a register transfer level logic circuit comprising at least one clocked output state-holding element responsively coupled to at least one clocked input state-holding element from a behavioral description describing a processing operation of the logic circuit, the apparatus comprising:
a low power consumption circuit generation unit for generating a low power consumption circuit which stops or inhibits circuit operations of the at least one clocked output state-holding element unless a respective input to any one of said at least one of the clocked input state-holding element is valid by stopping or reducing clock supply to the at least one clocked output state-holding element, so to achieve low power consumption.

10. The high-level synthesis apparatus according to claim 9, wherein the low power consumption circuit generation unit includes:
an input synthesizing unit responsive to the behavioral description for synthesizing for each of said clocked input state-holding elements a respective synthesized clocked input state-holding element and a respective valid line whose value indicates whether a respective input of the clocked input state-holding element is valid,
an output synthesizing unit responsive to the behavioral description for synthesizing a synthesized clocked output state-holding element, and
a logic synthesizing unit responsive to the behavioral description for synthesizing logic coupled to each of said synthesized clocked input state-holding elements and to said synthesized clocked output state-holding element for conveying a clock gating signal to the synthesized clocked output state-holding element only if the respective inputs of all of the synthesized clocked input state-holding elements coupled to the synthesized clocked output state-holding element are indicated as being valid.

11. The high-level synthesis apparatus according to claim 9, wherein the low power consumption circuit generation unit includes:
an input synthesizing unit responsive to the behavioral description for synthesizing for each of said clocked input state-holding elements a respective synthesized clocked input state-holding element and a respective valid line whose value indicates whether a respective input of the clocked input state-holding element is valid,
an output synthesizing unit responsive to the behavioral description for synthesizing a synthesized clocked output state-holding element,
a detector for detecting a changed state for each of the synthesized clocked input state-holding elements coupled to the synthesized clocked output state-holding element and indicating a changed state on the valid line of the respective synthesized clocked input state-holding element, and
a clock gating unit for gating the clock of the synthesized clocked output state-holding element so as to latch the synthesized clocked output state-holding element whenever a changed state is detected in one or more of the synthesized clocked input state-holding elements coupled to the synthesized clocked output state-holding element.

12. A method of reducing power consumption in a circuit having one or more combinatorial logic islands comprising a clocked output state-holding element having inputs that are respective logic functions of one or more clocked input state-holding elements, the method comprising:
analyzing said circuit to determine said combinatorial logic islands;
individually optimizing each of said combinatorial logic islands according to conventional methods and recording a respective power consumption for each optimized combinatorial logic island;
adding valid lines and clock gating logic to each combinatorial logic island so as to form respective combined combinatorial logic islands and clock gating logic and optimizing each combined combinatorial logic island and clock gating logic by: associating with each of the clocked input state-holding elements in the respective combinatorial logic island a respective valid line whose value indicates whether a respective input of the clocked input state-holding element is valid; and
clock gating the clocked output state-holding element in the respective combinatorial logic island only if the respective inputs of all of the clocked input state-holding elements coupled to the clocked output state-holding element are indicated as being valid;
evaluating the respective power consumptions of each combinatorial logic island and determining whether any power saving in the combined combinatorial logic islands and clock gating logic exceeds a corresponding power requirement for adding the clock gating logic;
if the power saving is less than the power requirement for adding the clock gating logic, using the respective combinatorial logic island without adding the clock gating logic, and generating the output's valid lines for a successive logic stage; and
if the power saving exceeds the power requirement for adding the clock gating logic, using the respective combined combinatorial logic island and clock gating logic.

13. A method for producing a logic circuit, wherein the method according to claim 12 is used to reduce power consumption of the logic circuit.

14. A computer readable recording medium comprising a control program for executing the method according to claim 12.
